(19) United States
(12) Patent Application Publication
(10) Pub. No.: US 2017/0220422 A1
(43) Pub. Date: Aug. 3, 2017

(54) MOVING DATA CHUNKS

(71) Applicant: HEWLETT PACKARD ENTERPRISE DEVELOPMENT LP, Houston, TX (US)

(72) Inventor: John Butt, Bristol (GB)

(21) Appl. No.: 15/328,574

(22) PCT Filed: Aug. 28, 2014
(86) PCT No.: PCT/US2014/053158

§ 371 Date: Jan. 24, 2017

(51) Int. Cl. G06F 11/14; G06F 17/30

(52) U.S. Cl. CPC G06F 11/1453; G06F 17/30159; G06F 17/30486; G06F 17/30504; G06F 2201/80; G06F 2201/82

(57) ABSTRACT

Store data chunks associated with data objects to data store files. Determine for each of the data store files reference counts for each of the data chunks indicating number of data objects associated with respective data chunks. Move data chunks to one of the data store files based on whether respective reference counts of respective data chunks exceeds a threshold.

### BACKGROUND

Computer systems are coupled to storage systems to store and retrieve data. In some examples, the data may be arranged as files as part of a file system. A file system may include data blocks which are groups of data comprised of bytes of data organized as files as part of directory structures. A host may send to the storage system write commands to write data blocks from the host to the data storage. Further, a host may send to the storage system read commands to read data blocks back from storage and return the data blocks to the host.

### BRIEF DESCRIPTION OF THE DRAWINGS

FIG. 1 is a block diagram of a computer system for moving data chunks according to an example implementation.

FIG. 2 is a flow diagram of a computer system for moving data chunks of FIG. 1 according to an example implementation.

FIG. 3 is a diagram of operation of a computer system for moving data chunks according to an example implementation.

FIG. 4 is an example block diagram showing a non-transitory, computer-readable medium that stores instructions for a computer system for moving data chunks in accordance with an example implementation.

### DETAILED DESCRIPTION

Computer systems are coupled to storage systems to store and retrieve data. In some examples, the data may be arranged as files as part of a file system. A file system may include data blocks which are groups of data comprised of bytes of data organized as files as part of directory structures. A host may send to the storage system write commands to write data blocks from the host to data storage to back up the file system for possible future restore of the file system. Further, a host may send to the storage system read commands to read data blocks back from storage and return the data blocks to the host to restore portions the file system that have encountered errors or data loss.

The storage system may include a deduplication system or module with functionality to perform deduplication on data received from a host and then store the deduplicated data to data storage. In this context, data deduplication functionality may include data compression techniques to reduce or eliminate duplicate copies of repeating data. In one example, the data deduplication process may include receiving input data files from hosts, partitioning the input data files into groups of data referred to as data chunks, and then determining whether copies of the data chunks already exist on the storage system or as data store files on the storage system. The deduplication system may include data objects which are data structures associated with the input data files. The data objects may represent metadata of the data chunks which include pointers to the location of the data chunks stored on the data store files. If a copy of the data chunk already exists on the data store files, then another copy is not made, but rather a pointer is added to an index data structure to make reference to the original copy of the data chunk thereby reducing the need to make an additional copy and the storage capacity needed to store data files.

It may be desirable for storage systems to store data files on different tiers of storage. Storage tier techniques may help improve storage performance such as throughput performance, reduce storage cost, improve system robustness and so on. Different tiers of storage may be defined as a plurality of storage devices having a range of performance characteristics such as latency or speed or access time of the storage devices. The speed or access time or response time of a storage device is a measure of the time it takes before a storage device or drive can actually transfer data. The speed may include the time to read data from or write data to storage devices. In one example, hard disk drives (HDDs) have rotating medium to store data and may have relatively low speed or high latency compared to solid state drives (SSDs) which have memory cells to store data and have high speed or low latency. In general, HDDs have a high latency (slow speed) and lower cost for storage capacity compared to SSDs which have low latency (fast speed) and higher cost.

Disclosed are techniques that may help achieve improve storage performance or requirements in storage systems including systems having deduplication functionality. For example, the techniques may include a reference count that may count or keep track of the number of data chunks of data of the files as a result of the deduplication process. The reference counts associated with the data chunks may provide a method of determining which data store files are candidates to move or copy to different storage systems or tiers to improve storage performance or meet user requirements. The reference counts may also provide a means of identifying groups of high accessed data chunks or low access data chunks that may be moved or relocated to the same file as other high access data chunks or low access data chunk. These files may then become candidates to move or copy to different storage tiers. For example, storage tiers may be defined as storage devices having a range of different speeds or latencies ranging from high speed devices to low speed devices.

In one example, a deduplication system may receive data from input data files and then divide or partition the data into data chunks. In some examples, the data chunks may be used or represent a lowest level of deduplication granularity. Multiple data objects may reference the same data chunks, so file data stores may include a reference count to allow the system to determine how many data objects require or are dependent on access to a specific data chunk. The reference count may therefore provide a means to determine how often the data chunk is required or accessed within the deduplication system and therefore a means to determine how and where the files containing the data chunk should be stored. The technique of using a reference count to track data chunks may provide the ability to group data chunks in data store files depending on usage. These data store files may then be moved between storage tiers or duplicated to improve storage performance including system robustness or throughput performance characteristics. A reference count of a data chunk contained within a specific data store file may also provide a means of determining user data object usage at the file level, thereby providing a mechanism for storage decision making.

In one example, disclosed is an apparatus that includes a management module to store data chunks associated with data objects to data store files. The management module may be configured to determine for each of the data store files reference counts for each of the data chunks indicating number of data objects associated with respective data chunks. The management module may be configured to determine whether to move data chunks to one of the data store files devices based on whether respective reference counts of respective data chunks exceeds a threshold.

In some examples, the management module may be configured to receive input data files and partition the input data files into data chunks representing groups of data for deduplication. The management module may be configured to perform deduplication process on the data chunks of the data objects. The management module may be configured to compare data chunks from different data objects wherein if a second data chunk associated with a second data object is associated with a first data chunk of a first data object, then add a reference pointer to the second data chunk to make reference to the first data chunk. The management module may be configured to move data chunks that exceed a reference count threshold from low speed storage devices to high speed storage devices.

In this manner, these techniques may help improve storage performance by allowing the system to move or copy data files to different storage systems or tiers to provide user benefits or meet performance requirements. For example, it may be desirable for the system to store frequently accessed data files on fast speed (low latency) but more expensive storage devices and less frequently accessed data on less expensive but slower (higher latency) storage devices. Furthermore, the system may determine how many user data objects within a deduplication system are dependent on a specific data chunk or data store file which allows for manual or automated control over which chunks are stored in which data file and where in the system the file is stored. This may permit for use of tiered storage to provide performance benefits and save multiple instances of specific files to reduce the likelihood of data loss due to file corruption.

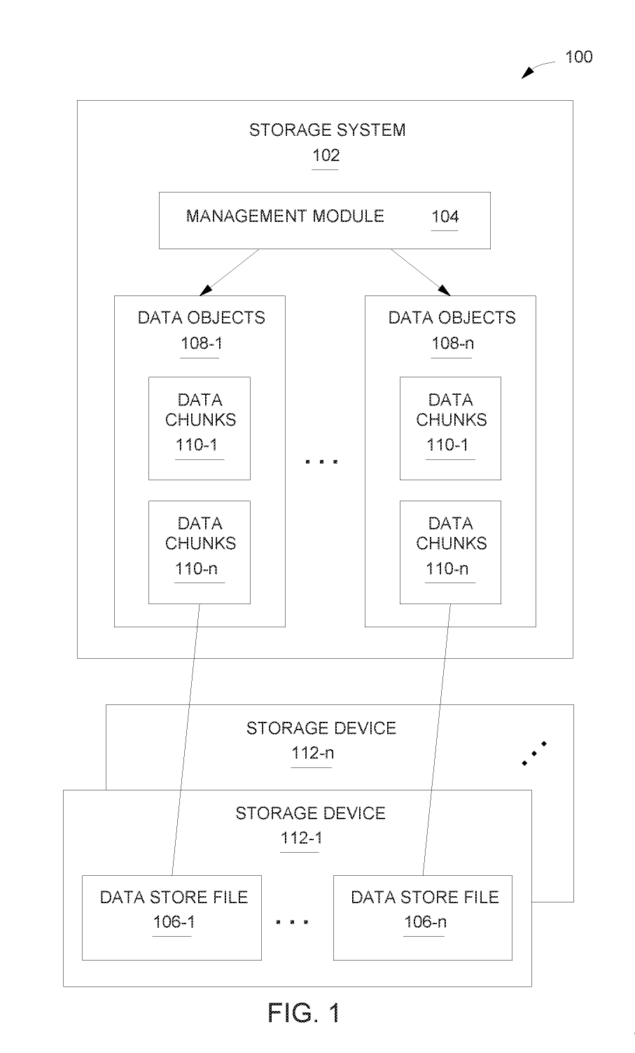

FIG. 1 is a block diagram of a computer system 100 for moving data chunks according to an example implementation. The computer system 100 includes a storage system 102 to manage storage devices 112 (112-1 through 112-n).

In one example, computer system 100 is coupled to storage devices 112 as part of storage mechanisms with data storage to store and retrieve data. In one example, the data is grouped or arranged as files as part of a file system. A file system may include data blocks which are groups of data comprised of bytes of data organized as files as part of directory structures. Another device or system, such as a host (not shown), may send to storage system 102 write commands to write data blocks from the host to the data storage. Further, the host may send to storage system 102 read commands to read data blocks back from storage and return the data blocks to the host.

The storage system 102 may be an apparatus that includes a management module 104 to manage the operation of the storage system including communication with storage devices 112 and other devices such as host devices or computers. The management module 104 may interact with a host to process write commands to write data blocks from the host to the data storage. The management module 104 may interact with a host to process read commands to read data blocks back from storage and return the data blocks to the host.

In one example, management module 104 may be configured to store data chunks 110 associated with data objects 108 (108-1 through 108-n) to data store files 106 (106-1 through 106-n). The management module 104 determines for each of data store files 106 reference counts for each of data chunks 110. The reference counts indicate number of data objects 108 associated with respective data chunks. The management module 104 determines whether to move data chunks 110 to one of data store files 106 based on whether respective reference counts of respective data chunks exceeds a threshold. In one example, threshold may be based on user or performance requirements such as range of speed of storage devices 112, characteristics of the input data, and the like.

The management module 104 may be configured to receive input data files and partition the input data files into data chunks 110 representing groups of data for deduplication. The management module 104 may be configured to perform deduplication process on data chunks 110 of data objects 108. The management module 104 may be configured to compare data chunks 106 from different data objects 108. In one example, if a second data chunk associated with a second data object is associated with a first data chunk of a first data object, then management module 104 adds a reference pointer to the second data chunk to make reference to the first data chunk. The management module 104 may be configured to move data chunks 110 that exceed a reference count threshold from low speed storage devices to high speed storage devices. For example, second storage device 112-2 may be a low speed device, such as a HDD, and first storage device 112-2 may be a high speed device such as a SSD. In this case, management module 104 may decide to move particular data store files 106 from low speed storage device 112-2 to high speed storage device 112-1.

The management module 104 may include a deduplication module having functionality to perform deduplication on data received from another device or computer, such as a host, and then store the deduplicated data to data storage such as storage devices 112. In this context, data deduplication functionality may include any data compression technique to reduce or eliminate duplicate copies of repeating data. In one example, the data deduplication process may include receiving input data files from hosts, partitioning the input data files into data chunks 110, and then determining whether copies of the data chunks exist on storage devices 112 on the output or data store files 106. The deduplication module may manage data objects 108 which are data structures associated with the input data files and represent metadata of the data chunks which include pointers to the location of the data chunks stored on data store files 106. If a copy of the data chunk 110 already exists on data store files 106, then another copy is not made, but rather a pointer is added to an index data structure to make reference to the original copy of the data chunk thereby reducing the need to make an additional copy and reducing the storage capacity needed to store to data store files 106.

In this manner, these techniques may help improve storage performance by allowing storage system 102 to move or copy data chunks 110 or data store files 106 having data chunks to different storage devices 112 or tiers to provide user benefits or to meet performance requirements. For example, it may be desirable for storage system 102 to store frequently accessed data files on fast speed but more expensive storage devices 112 and less frequently accessed data on less expensive but slow speed storage devices. Furthermore, storage system 102 may determine how many data objects 108 within a deduplication system are dependent on a specific data chunk 110 or data store file 106 which allows for manual or automated control over which chunks are stored in which data file and where in the system the file is stored. This may permit for use of tiered storage to provide performance benefits and save multiple instances of specific files to reduce the likelihood of data loss due to file corruption.

The storage system 102 may be any electronic device capable of data processing such as a server computer, mobile device and the like. The functionality of the components of storage system 102 may be implemented in hardware, software or a combination thereof. The storage system may communicate with storage devices 112 and other devices such as hosts using any electronic communication means including wired, wireless, network based such as storage area network (SAN), Ethernet, Fibre Channel and the like.

The storage devices 112 includes a plurality of storage devices 112-1 through 112-n configured to present logical storage devices to other devices such as hosts. In one example, devices coupled to storage system 102, such as hosts, may access the logical configuration of storage array as LUNS. The storage devices 112 may include any means to store data for later retrieval. The storage devices 112 may include non-volatile memory, volatile memory or a combination thereof. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices 112 may include, but are not limited to, HDDs, CDs, DVDs, SSDs optical drives, flash memory devices and other like devices.

It should be understood that the description of storage system 102 above is for illustrative purposes and other implementations of the system may be employed to practice the techniques of the present application. For example, storage system 102 is shown as a single component but the storage system may include a plurality of storage systems coupled to storage devices 112.

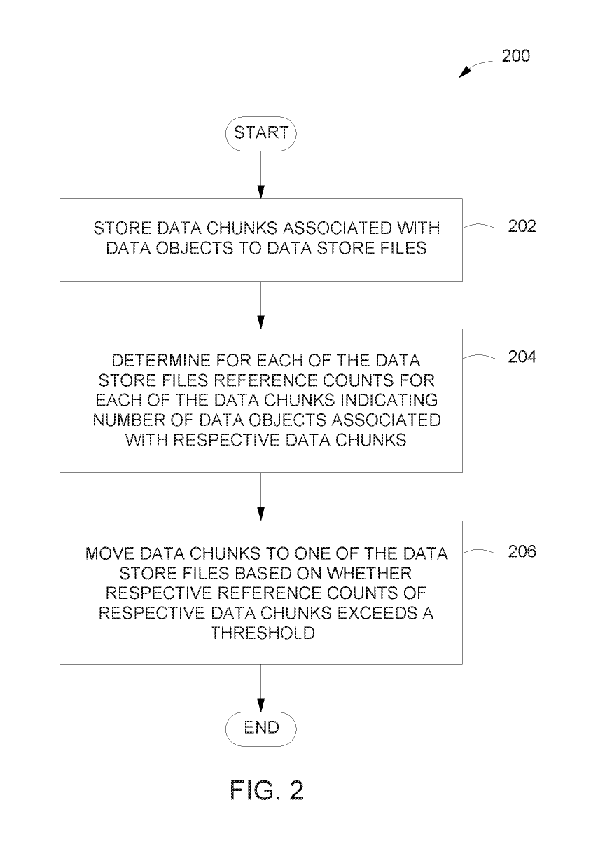

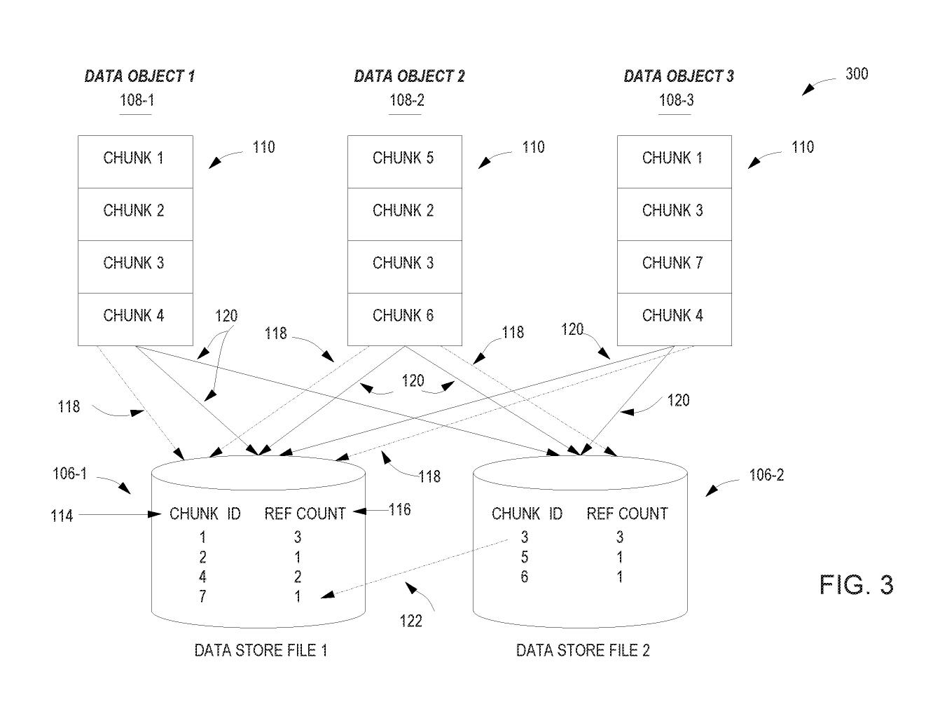

FIG. 2 and FIG. 3 will be used to describe an example operation of the present techniques according to an example implementation.

In one example, to illustrate operation, it may be assumed that management module 104 may be configured to store data chunks 110 associated with three data objects 108 (108-1, 108-2, 108-3) to two data store files 106 (106-1, 106-2). The management module 104 provides chunk identifiers 114 for each of data store files 106 and reference counts 116 for each of data chunks 110 indicating number of data objects 108 associated with respective data chunks. As explained below, management module 104 determines whether to move data chunks 110 to one of data store files 106 based on whether respective reference counts of respective data chunks exceeds a threshold. In one example, management module 104 may move particular data chunks 110 to a single data store file 106

It may be further assumed, to illustrate operation, that management module 104 receives input data files and partitions the input data files into data chunks 110 representing groups of data for deduplication. The management module 104 may be configured to perform deduplication process on data chunks 110 of data objects 108. In one example, management module 104 compares data chunks 110 from different data objects 108. If a second data chunk associated with a second data object is associated with a first data chunk of a first data object, then management module 104 adds a reference pointer to the second data chunk to make reference to the first data chunk. The management module 104 moves data chunks 110 that exceed a reference count threshold from low speed storage devices to high speed storage devices 112. To illustrate, it may be assumed that first data store file 106-1 is stored on a first storage device 112-1 that is high speed and that second store file 106-2 is stored on a second storage device 112-2 that is low speed. In one example, first storage device 112-1 may be a SSD while second storage device 112-2. As explained above, HDDs have rotating medium to store data and may have relatively low speed or high latency compared to SSDs which have memory cells to store data and have high speed or low latency.

To illustrate operation, it may be further assumed that management module 104 includes a deduplication module having functionality to perform deduplication on data received from the host and then store the deduplicated data to data storage such as storage devices 112. In one example, the data deduplication process includes receiving input data files from hosts or other devices, partitioning the input data files into data chunks 110, and then determining whether copies of the data chunks exist on storage devices 112 or data store files 106. The data objects 108 are associated with the input data files and represent metadata of the data chunks which include pointers to the location of the data chunks stored on data store files 106.

Processing may begin at block 202, wherein management module 104 stores data chunks 110 associated with data objects 108 to data store files 106. In particular, in one example, management module 104 receives three data files from another system or device, such as a host, and assigns the data files to respective first data object 108-1, second data object 108-2 and third data object 108-3. The management module 104 assigns first data object 108-1 with pointers or references to data chunks 110 including data Chunk 1, data Chunk 2, data Chunk 3 and data Chunk 4. In a similar manner, management module 104 assigns second data object 108-2 with pointers or references to data chunks 110 including data Chunk 5, data Chunk 2, data Chunk 3 and data Chunk 6. Likewise, management module 104 assigns third data object 108-3 with pointers or references to data chunks 110 including data Chunk 1, data Chunk 3, data Chunk 7 and data Chunk 4.

In one example, management module 104 generates data store files 106 to store data chunks 110 associated with data objects 108. In particular, management module 104 writes to first data store file 106-1 data chunks with chunk identifiers 114 including data Chunk 1, data Chunk 2, data Chunk 4 and data Chunk 7. In a similar manner, management module 104 writes to second data store file 106-2 data chunks with chunk identifiers 114 including data Chunk 3, data Chunk 5, and data Chunk 6.

In this case, management module 104 generates or creates data objects 108 and includes pointers to data chunks 110 that are shared (deduplicated) between data objects. The management module 104 stores data chunks 110 in one of two data store files 106-1, 106-2. The management module 104 includes, for each of data store files 106, reference counts 116 which are maintained for each of data chunk 110 which indicates how many data objects are reliant on the data chunks. In the case, this reliance is represented by solid lines 120 where each data object must access both data store files 106 to recover all data.

At block 204, management module 104 determines for each of the data store files 106 reference counts 116 for each of data chunks 110 indicating number of data objects associated with respective data chunks. In this example, management module 104 determines, for first data store file 106-1, references counts 116 including a reference count of 3 for data chunk 1, a reference count of 1 for data Chunk 2, a reference count of 2 for data Chunk 4 and a reference count of 1 for data Chunk 7. In a similar manner, management module 104 determines, for second data store file 106-2, references counts 116 including a reference count of 3 for data Chunk 3, a reference count of 1 for data Chunk 5, and a reference count of 1 for data Chunk 6.

At block 206, management module 104 moves data chunks 110 to one of the data store files 106 based on whether respective reference counts 116 of respective data chunks exceeds a threshold. In this example, management module 104 checks reference count 116 of second data store file 106-2 and determines that the reference count exceeds a threshold value of 2 and thus moves data Chunk 3 to first data store file 106-1, as shown by dashed line 122. In the case, a single data chunk is moved from second data store 106-2 to first data store file 106-2. As explained above, first data store 106-1 is stored on first storage device 112-1 which is a SSD while second data store 106-2 is stored on second storage device 112-2 which is a HDD. In general, HDDs have a high latency (slow speed) and lower cost for storage capacity compared to SSDs which have low latency (fast speed) and higher cost. The movement of data is a result of user or storage requirements to keep data chunks with the highest reference counts in the same data file. In this manner, data object 1 and data object 3 can recover all data by accessing a single data file and only data object 2 still has to access both data files to recover all data.

In other words, in this example, solid lines 120 show that to recover first data object 108-1, management module 104 must read chunk identifiers 1, 2, 3 and 4 from data store files. In this case, both first data store file 106-1 and second data store file 106-2 need to be accessed, as chunk identifiers 1, 2 and 4 are in first data store file 106-1 and chunk identifier 3 is in second data store file 106-2. If now data Chunk 3 is moved from second data store file 106-2 to first data store file 106-1 shown by solid line 122, as Chunk 3 has a high reference count, now data Chunks 1, 2, 4, 7 and 3 are stored in first data store file 106-1. In this case, dotted lines 118 shows that to recover first data object 108-1, management module 104 can read all required chunk identifiers (1,2,3 and 4) from first data store file 106-1 and does not need to access second data store file 106-2. That is, this technique helps reduce the amount of file input output (IO) required to recover all data chunks of data that make up or comprise first data object 108-1.

In this manner, these techniques may help improve storage performance by allowing storage system 102 to move or copy data chunks 110 or data store files 106 to different storage devices 112 or tiers to provide storage requirements and other benefits. For example, it may be desirable for storage system 102 to store frequently accessed data files on fast speed but more expensive storage devices 112 and less frequently accessed data on less expensive but slow speed storage devices. Furthermore, storage system 102 may determine how many data objects 108 within a deduplication system are dependent on a specific data chunks 110 or data store files 106 which allows for manual or automated control over which chunks are stored in which data file and where in the system the file is stored. This may permit for use of tiered storage to provide performance benefits and save multiple instances of specific files to reduce the likelihood of data loss due to file corruption.

It should be understood that the above process 200 is for illustrative purposes and that other implementations may be employed to the practice the techniques of the present application. For example, management module 104 may employ different criteria other than reference counts or different levels of thresholds to make determinations to move data chunks to different data store files.

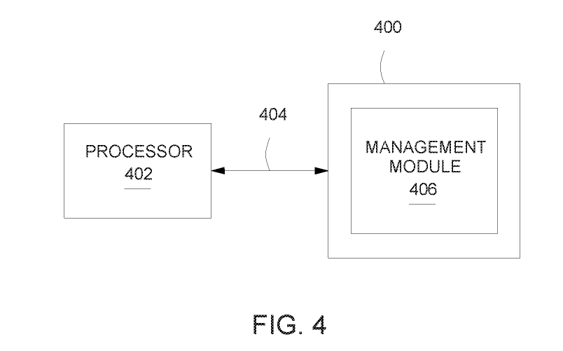

FIG. 4 is an example block diagram showing a non-transitory, computer-readable medium that stores instructions for a computer system for moving data chunks in accordance with an example implementation. The non-transitory, computer-readable medium is generally referred to by the reference number 400 and may be included in devices of system 100 as described herein. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, EEPROM and ROM. Examples of volatile memory include, but are not limited to, SRAM, and DRAM. Examples of storage devices include, but are not limited to, hard disk drives, compact disc drives, digital versatile disc drives, optical drives, and flash memory devices.

A processor 402 generally retrieves and executes the instructions stored in the non-transitory, computer-readable medium 400 to operate the devices of system 100 in accordance with an example. In an example, the tangible, machine-readable medium 400 may be accessed by the processor 402 over a bus 404. A first region 406 of the non-transitory, computer-readable medium 400 may include management module functionality as described herein.

Although shown as contiguous blocks, the software components may be stored in any order or configuration. For example, if the non-transitory, computer-readable medium 400 is a hard drive, the software components may be stored in non-contiguous, or even overlapping, sectors.

What is claimed is:

1. A method comprising:
storing data chunks associated with data objects to data store files;
determining for each of the data files reference counts for each of the data chunks indicating number of data objects associated with respective data chunks; and
moving data chunks to one of the data store files based on whether respective reference counts of respective data chunks exceeds a threshold.

2. The method of claim 1, further comprising receiving input data files and partitioning the input data files into data chunks representing groups of data for deduplication.

3. The method of claim 1, further comprising performing deduplication process on the data chunks

4. The method of claim 1, further comprising performing deduplication process on the data chunks of the data objects which includes comparing data chunks from different data objects wherein if a second data chunk associated with a second data object is associated with a first data chunk of a first data object, then adding a reference pointer to the second data chunk to make reference to the first data chunk.

5. The method of claim 1, further comprising moving data chunks that exceed a reference count threshold from low speed storage devices to high speed storage devices.

6. An apparatus comprising:
a management module to:
store data chunks associated with data objects to data store files,
determine for each of the data store files reference counts for each of the data chunks indicating number of data objects associated with respective data chunks, and
determine whether to move data chunks to one of the data store files devices based on whether respective reference counts of respective data chunks exceeds a threshold.

7. The apparatus of claim 6, wherein the management module to receive input data files and partition the input data files into data chunks representing groups of data for deduplication.

8. The apparatus of claim 6, wherein the management module to perform deduplication process on the data chunks of the data objects.

9. The apparatus of claim 6, wherein the management module to compare data chunks from different data objects wherein if a second data chunk associated with a second data object is associated with a first data chunk of a first data object, then add a reference pointer to the second data chunk to make reference to the first data chunk.

10. The apparatus of claim 6, wherein the management module to move data chunks that exceed a reference count threshold from low speed storage devices to high speed storage devices.

11. An article comprising a non-transitory computer readable storage medium to store instructions that when executed by a computer to cause the computer to:
store data chunks associated with data objects to data store files;
determine for each of the data store files reference counts for each of the data chunks indicating number of data objects associated with respective data chunks; and
if respective reference counts of respective data chunks exceeds a threshold, then move data chunks to one of the data store files.

12. The article of claim 11, further comprising instructions that if executed cause a computer to receive input data files and partition the input data files into data chunks representing groups of data for deduplication.

13. The article of claim 11, further comprising instructions that if executed cause a computer to perform deduplication process on the data chunks of the data objects.

14. The article of claim 11, further comprising instructions that if executed cause a computer to compare data chunks from different data objects wherein if a second data chunk associated with a second data object is associated with a first data chunk of a first data object, then add a reference pointer to the second data chunk to make reference to the first data chunk.

15. The article of claim 11, further comprising instructions that if executed cause a computer to move data chunks that exceed a reference count threshold from low speed storage devices to high speed storage devices.
